(19) United States
(12) Patent Application Publication
(10) Pub. No.: US 2025/0346032 A1
(43) Pub. Date: Nov. 13, 2025

(54) LIQUID EJECTION HEAD, LIQUID EJECTION APPARATUS, AND METHOD FOR MANUFACTURING LIQUID EJECTION HEAD

(71) Applicant: CANON KABUSHIKI KAISHA, Tokyo (JP)

(72) Inventors: TORU KANDA, Kanagawa (JP); TAKUYA IWANO, Tokyo (JP); KOJI TACHIBANA, Kanagawa (JP)

(21) Appl. No.: 19/201,655

(22) Filed: May 7, 2025

(30) Foreign Application Priority Data
May 13, 2024 (JP) 2024-077929

(51) Int. Cl. B41J 2/165; B41J 2/16

(52) U.S. Cl. CPC B41J 2/16507; B41J 2/16; B41J 2/1623

(57) ABSTRACT

A liquid ejection head includes a liquid ejection substrate configured to have an orifice face provided with an ejection orifice that ejects liquid, a face cover configured to be bonded to the liquid ejection substrate and protect the orifice face, and a support member configured to support the face cover, wherein the support member is provided with a groove in a surface to which the face cover is bonded, the groove partially overlapping the face cover when seen from a direction perpendicular to the orifice face, and wherein the liquid ejection head includes resin provided over a space surrounded by the support member and the face cover, and the groove, the resin forming an inclined surface toward the orifice face.

### BACKGROUND

### Field

The present disclosure relates to a liquid ejection head, a liquid ejection apparatus, and a method for manufacturing the liquid ejection head.

### Description of the Related Art

A liquid ejection head includes liquid ejection substrates provided with ejection orifices that eject liquid. The liquid ejection substrates are typically disposed on a support member, which also functions as a flow path member that supplies liquid. The liquid ejection substrates eject the supplied liquid from the ejection orifices and perform recording or the like on a recording medium. When the recording medium is conveyed, if the end portion of the recording medium is curved (curled), the end portion of the recording medium may come into contact with the side surface of the liquid ejection head, and jamming (a paper jam) may occur.

As a method for preventing the above problem, Japanese Patent Application Laid-Open No. 2023-66364 discusses a liquid ejection head that includes a nozzle plate provided with nozzles (ejection orifices) that eject liquid to an ejection target, a nozzle protection member that covers at least part of the nozzle face of the nozzle plate except for the nozzles, the nozzle face facing in the liquid ejection direction, and a nozzle-protection-member holding member that has a peripheral wall portion bonded to the nozzle protection member. In this liquid ejection head, a resin member is provided between the side surface of the nozzle protection member, the side surface being bonded to the nozzle-protection-member holding member, and the surface of the peripheral wall portion, the surface facing the liquid ejection direction. This structure allows the recording medium to pass between the liquid ejection head and the recording medium conveyance surface, even if the end portion of the recording medium is curved. As a result, occurrence of jamming is reduced. In addition, occurrence of peeling of the nozzle protection member is reduced.

However, the resin member provided to prevent the recording medium from coming into contact with the side surface of the nozzle protection member, which is a face cover, is weak against the force in the direction from the side surface, and the resin member could come off due to the contact with the recording medium.

### SUMMARY

According to an aspect of the present disclosure, a liquid ejection head includes a liquid ejection substrate configured to have an orifice face provided with an ejection orifice that ejects liquid, a face cover configured to be bonded to the liquid ejection substrate and protect the orifice face, and a support member configured to support the face cover, wherein the support member is provided with a groove in a surface to which the face cover is bonded, the groove partially overlapping the face cover when seen from a direction perpendicular to the orifice face, and wherein the liquid ejection head includes resin in a space surrounded by the support member and the face cover and in the groove, the resin forming an inclined surface toward the orifice face.

According to another aspect of the present disclosure, a method for manufacturing a liquid ejection head that includes a liquid ejection substrate configured to have an orifice face provided with an ejection orifice that ejects liquid, a face cover configured to be bonded to the liquid ejection substrate and protect the orifice face, and a support member configured to support the face cover, wherein the support member is provided with a groove in a surface to which the face cover is bonded, the groove partially overlapping the face cover when seen from a direction perpendicular to the orifice face, includes disposing resin over a space surrounded by the support member and the face cover, and the groove such that the resin forms an inclined surface toward the orifice face.

Further features of the present disclosure will become apparent from the following description of exemplary embodiments with reference to the attached drawings.

### BRIEF DESCRIPTION OF THE DRAWINGS

FIG. 1 is a perspective view illustrating a schematic structure of a liquid ejection apparatus according to a first exemplary embodiment.

FIGS. 2A and 2B are perspective views of a liquid ejection head according to the first exemplary embodiment.

FIG. 3 is a plan view of a liquid ejection unit not yet been disposed on a support member according to the first exemplary embodiment.

FIG. 4A is an example of a top view of the liquid ejection units disposed on the support member according to the first exemplary embodiment, and FIG. 4B is an example of a side view of the liquid ejection units according to the first exemplary embodiment.

FIGS. 5A and 5B are examples of sectional views of a liquid ejection head according to the first exemplary embodiment.

FIG. 6 is an example of a plan view of the support member according to the first exemplary embodiment.

FIGS. 7A to 7C illustrate part of a manufacturing process of the liquid ejection head according to the first exemplary embodiment.

FIG. 8 is another example of a sectional view of the liquid ejection head according to the first exemplary embodiment.

FIG. 9 is another example of a top view of the liquid ejection head according to the first exemplary embodiment.

FIG. 10 is an example of a sectional view of a liquid ejection head according to a second exemplary embodiment.

### DESCRIPTION OF THE EMBODIMENTS

Exemplary embodiments of the present disclosure will be described with reference to the drawings.

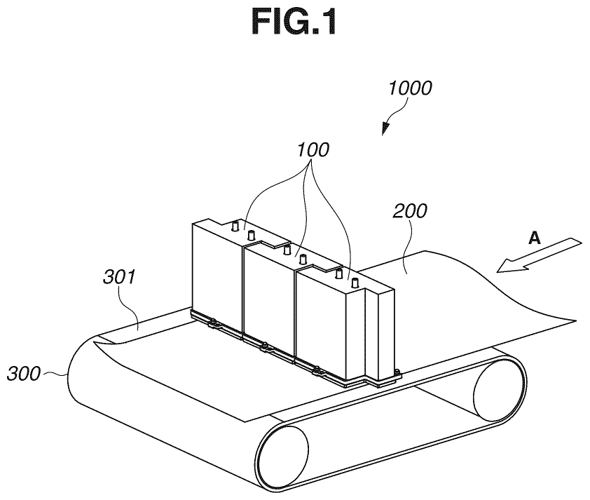

A first exemplary embodiment will be described. FIG. 1 is a perspective view illustrating a schematic structure of a liquid ejection apparatus 1000 to which the present disclosure can be applied. The liquid ejection apparatus 1000 includes a conveyance unit 300 that conveys a recording medium 200, and liquid ejection heads 100 that eject liquid such as ink. The conveyance unit 300 conveys the recording medium 200 toward the liquid ejection heads 100. Cut paper or roll paper is generally used as the recording medium 200. However, other media may also be used. Recording is performed when the recording medium 200 passes between the liquid ejection heads 100 and a support surface 301 of the conveyance unit 300. The recording medium 200 is conveyed in the direction indicated by an arrow A illustrated in FIG. 1. The liquid ejection heads 100 according to the present exemplary embodiment are line-type heads having a length corresponding to the width of the recording medium 200 (the width of the recording medium 200 in a direction perpendicular to the conveyance direction A). However, the present disclosure can also be applied to serial-type heads that eject liquid while performing a reciprocating motion.

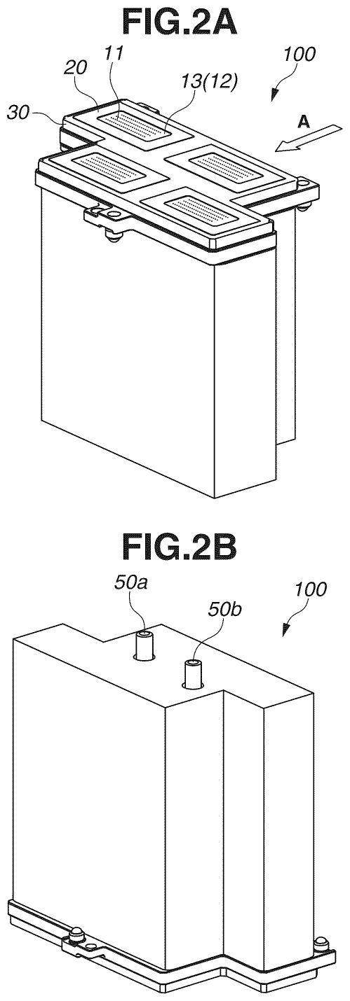

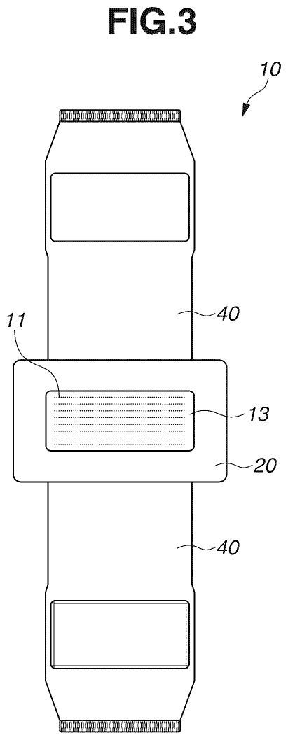

FIG. 2A is a perspective view of a liquid ejection head 100 according to the present exemplary embodiment, seen from orifice faces 12 including ejection orifices 11. The liquid ejection head 100 illustrated in FIG. 2A includes liquid ejection units 10 (see FIG. 3) disposed on a support member 30. Each of the liquid ejection units 10 includes a liquid ejection substrate 13 provided with the ejection orifices 11 that eject liquid in an orifice face (a liquid ejection surface) 12, and includes a face cover 20 that protects the orifice face 12. The support member 30 supports the individual liquid ejection substrate 13 and the individual face cover 20, and includes flow paths that supply liquid to the ejection orifices 11. The individual liquid ejection unit 10 includes flexible wiring substrates 40 (see FIG. 3) that send, to its corresponding liquid ejection substrate 13, an electric signal for ejecting liquid. In the present exemplary embodiment, four liquid ejection units 10 are arranged in a staggered pattern on the support member 30 to form a line-type head. The number of liquid ejection units 10 can be suitably changed, depending on the required head length. The liquid ejection units may be arranged in a different pattern. For example, in-line arrangement may be used.

FIG. 2B is a perspective view of the liquid ejection head 100 according to the present exemplary embodiment, seen from the side opposite to the orifice face 12. The liquid ejection head 100 includes a liquid flow path portion 50 that connects a tank (not illustrated) outside the liquid ejection head 100 and the liquid ejection substrates 13, and liquid flows through the liquid flow path portion 50. The structure illustrated in FIG. 2B includes a liquid flow path portion 50a through which liquid is supplied to the liquid ejection head 100 and a liquid flow path portion 50b through which liquid is collected from the liquid ejection head 100.

Liquid such as ink is supplied to the ejection orifices 11 from the tank via the liquid flow path portion 50, the support member 30, and the liquid ejection substrates 13 in this order. The liquid ejection head 100 is also provided with a liquid circulation function, a temperature control function, a filter function, etc., as appropriate, depending on the physical properties of the liquid and the performance of the liquid ejection head 100.

FIG. 3 is a plan view of a liquid ejection unit 10 not yet been disposed on the support member 30.

The liquid ejection substrate 13 is a substrate including liquid flow paths and an energy generating element for ejecting liquid, and is formed of silicon for its base, for example. A plurality of ejection orifices 11 for ejecting liquid are formed in the surface of the liquid ejection substrate 13. The liquid ejection substrate 13 is made of photosensitive resin, for example. A face cover 20 is bonded to an orifice face 12 including the ejection orifices 11, to protect the orifice face 12. When seen from a direction perpendicular to the orifice face 12, the face cover 20 has an opening in which the ejection orifices 11 of the liquid ejection substrate 13 are exposed to the outside. In other words, when seen from a direction perpendicular to the orifice face 12, the face cover 20 has an opening in which the liquid ejection substrate 13 is disposed. The face cover 20 has a thickness of 0.1 mm to 0.5 mm, for example.

The liquid supplied to the liquid ejection substrate 13 is ejected from the ejection orifices 11 by driving the energy generating element included in the liquid ejection substrate 13. A heating element or a piezoelectric element is typically used as the energy generating element, and electric signals and electric power are supplied through flexible wiring substrates 40 electrically connected to the liquid ejection substrate 13. In the present exemplary embodiment, two flexible wiring substrates 40 are provided on two opposing sides of one liquid ejection substrate 13. The flexible wiring substrates 40 mainly include a base film, a cover film, and electric wires. The degree of freedom of deformation is improved by using a flexible resin such as polyimide resin for the base film and the cover film. The electric wires are made of copper foil or the like, and are bonded by adhesive such that the electric wires are sandwiched between the base film and the cover film. Part of the cover film is removed to expose part of the electric wires to the outside, and this exposed part of the electric wires is electrically connected to the liquid ejection substrate 13.

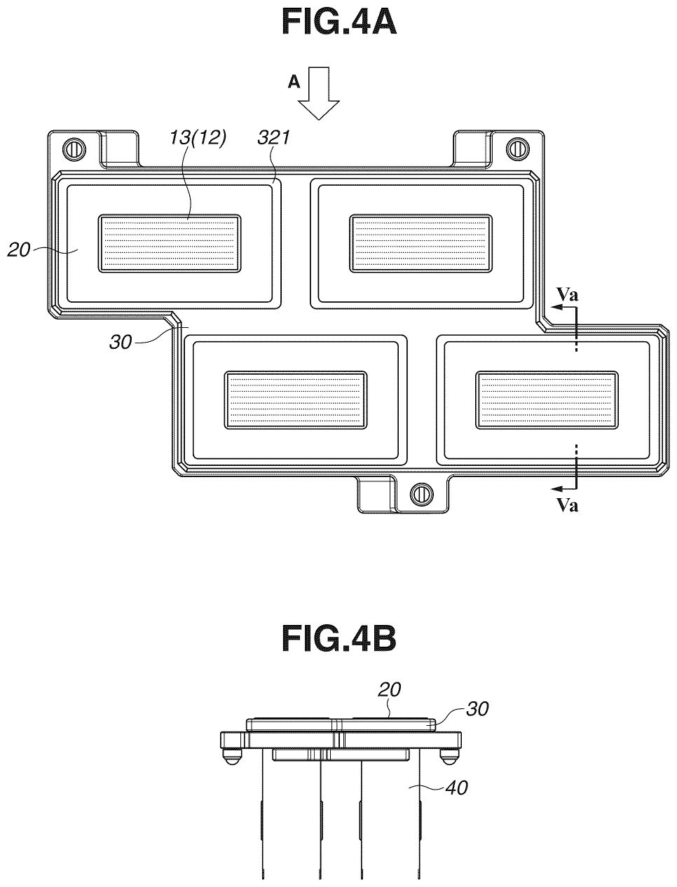

FIGS. 4A and 4B illustrate a state in which a plurality of liquid ejection units 10 are bonded to the support member 30 such that the heights of their respective orifice faces 12 are aligned. FIG. 4A is a plan view seen from a direction perpendicular to the orifice faces 12, and FIG. 4B is a side view seen from a direction perpendicular to the orifice faces 12. An arrow A in FIG. 4A indicates the conveyance direction of the recording medium 200, as in FIG. 1.

The “height” in the present description refers to a position in a direction perpendicular to the orifice face 12. The liquid ejection units 10 are accurately bonded to the support member 30 so as to achieve high definition recording. The support member 30 supports the liquid ejection units 10, and also serves as a flow path member having flow paths through which liquid is supplied to the liquid ejection substrates 13. Adhesive is applied to the support member 30 or the liquid ejection substrates 13 to bond each other without blocking the flow paths. It is preferrable that the adhesive be resistant to the ejected liquid. In the present exemplary embodiment, thermosetting epoxy resin is used and is heated at an actual temperature of 100° C. for curing. When the temperature of the liquid ejection head 100 changes due to the heating during the thermal curing of the adhesive or the heating during the temperature control of the ejection liquid, internal stress is generated due to the difference in linear expansion coefficient between the support member 30 and the liquid ejection substrates 13, and may damage the liquid ejection head 100.

For this reason, it is preferable that the difference in linear expansion coefficient between the support member 30 and the liquid ejection substrates 13 be small. In the present exemplary embodiment, alumina is used for the support member 30.

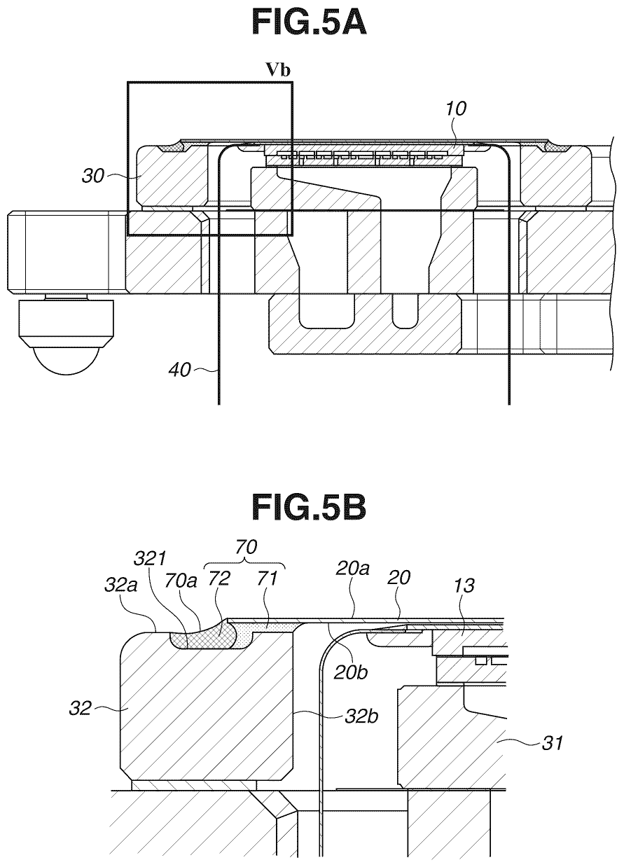

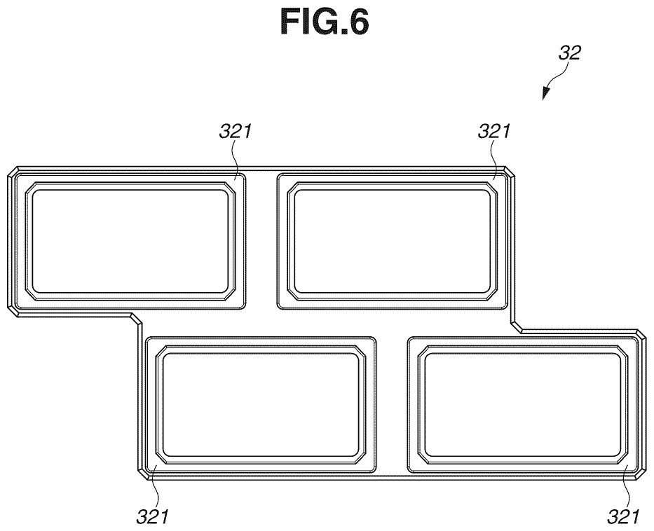

When the liquid ejection units 10 are bonded to the support member 30, as illustrated in FIG. 4B, the flexible wiring substrates 40 are bent by approximately 90° in a direction opposite to the support surface 301 such that the flexible wiring substrates 40 pass through the inside of the support member 30, and are connected to an electric substrate (not illustrated). FIG. 5A is a sectional view taken along a line Va-Va in FIG. 4A, and FIG. 5B is an enlarged view of a portion Vb in FIG. 5A. The support member 30 includes a first support member 31 that supports the liquid ejection substrate 13, and includes a second support member 32 that is disposed near the orifice face 12 supported by the first support member 31 and is bonded to the face cover 20. As illustrated in FIGS. 5A and 5B, the face cover 20 is bonded to the second support member 32 via a resin member 70. In the present exemplary embodiment, a surface 32a of the second support member 32, the surface 32a being bonded to the face cover 20, has a groove 321, which partially overlaps the face cover 20 when seen from a direction perpendicular to the orifice face 12. FIG. 6 is a plan view of the second support member 32 including the grooves 321. The individual resin member 70 is provided over a space surrounded by the second support member 32 and the corresponding face cover 20, and the corresponding groove 321. The structure including the grooves 321 and the resin members 70 as described above can provide an effect of improving the adhesion of the face covers 20 against the force applied from the side surface direction.

The individual resin member 70 forms an inclined surface 70a that extends from the surface and the end portion of the face cover 20 to the surface 32a of the second support member 32. In other words, a cover surface 20a of the face cover 20, the cover surface 20a being on the side opposite to the surface bonded to the second support member 32, the inclined surface 70a of the resin member 70, and the surface 32a of the second support member 32 form a continuous surface. This structure can provide effects of preventing the recording medium 200 from being caught by the end portion of the face cover 20 and removing the face cover 20, and reducing occurrence of jamming of the recording medium 200.

A method for manufacturing a liquid ejection head according to the present disclosure will be described.

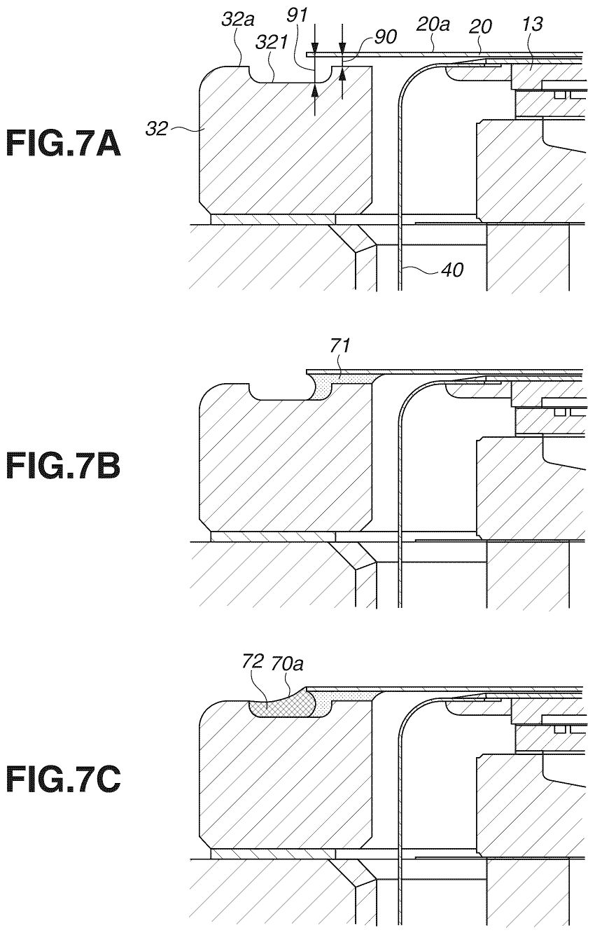

In the case of the individual liquid ejection head 100 according to the present exemplary embodiment, a plurality of liquid ejection units 10 is disposed on the support member 30 as described above. Each of the liquid ejection units 10 to be used has a different height. Accordingly, in the present exemplary embodiment, floating mount is performed to align the heights of the orifice faces 12. FIGS. 7A to 7C illustrate a process for disposing and fixing the individual liquid ejection unit 10 on the support member 30 with a resin member 70. FIG. 7A illustrates a liquid ejection unit 10 that has been disposed on the support member 30. In FIG. 7A, the resin member 70 has not yet been applied. The individual liquid ejection substrate 13 is bonded to the first support member 31 by adjusting the compression amount of the adhesive that fixes the liquid ejection substrate 13 to the first support member 31 such that the difference in heights of the orifice faces among the liquid ejection units 10 is absorbed.

When the floating mount is performed, if any of the face covers 20 comes into contact with the second support member 32, the heights of the liquid ejection units 10 are not aligned. Accordingly, as illustrated in FIG. 7A, a first gap (space) 90 is formed between the second support member 32 and the individual face cover 20. In the present exemplary embodiment, in the state illustrated in FIG. 7A, a second gap (space) 91 is formed in a space between the bottom portion of the groove 321 in the second support member 32 and the corresponding face cover 20. For example, if the recording medium 200 with a curved end portion is conveyed to the first gap 90, the end portion of the recording medium 200 may enter the first gap 90, instead of entering the path between the support surface 301 of the conveyance unit 300 and the liquid ejection head 100. If this happens, the recording medium 200 is deformed, and jamming occurs. When jamming occurs, the printing operation needs to be stopped to remove the jammed recording medium 200. The liquid ejection head 100 may also be damaged by the impact caused by the end portion of the recording medium 200 that has come into contact with the liquid ejection substrate 13 or the ejection orifices 11.

In the present exemplary embodiment, by applying the resin member 70 in the first gap 90 and the second gap 91, the adhesion strength of the liquid ejection head 100, particularly the face cover 20, is secured. As illustrated in FIG. 7A, the liquid ejection unit 10 is positioned on the support member 30 by floating. In this state, a first adhesive 71 is applied to the groove 321 in the second support member 32. At this point in time, when the first adhesive 71 comes into contact with the face cover 20, the first adhesive 71 is drawn into the first gap 90 by the capillary force of the first gap 90 and fills the first gap 90 (FIG. 7B). In the present exemplary embodiment, thermosetting resin is used as the first adhesive 71, and the first adhesive 71 is cured by heat while remaining in the first gap 90 due to the surface tension. It is preferrable that the first adhesive 71 have a low viscosity, so that the first gap 90 is filled by using capillary force. It is preferable that the viscosity before curing be 4.0 Pa·s or more and 132 Pa·s or less. The first adhesive 71 is not limited to the thermosetting resin, and for example, moisture-curable resin may be suitably used. It is preferrable that the height of the first gap 90 be set such that the first gap 90 is filled with the first adhesive 71 by capillary force.

In the present exemplary embodiment, as an example, the height of the first gap 90 is set to 0.2 mm.

A second adhesive 72 is applied to the groove 321 to fill the second gap 91, and is cured by heat or the like (FIG. 7C). The second adhesive 72 forms an inclined surface 70a that extends from the surface and the end portion of the face cover 20 to the surface 32a of the second support member 32 over the groove 321. In other words, when the second adhesive 72 is cured, a slope connecting the outer peripheral end of the face cover 20 and the outer peripheral end of the groove 321 is formed. The slope (inclined surface 70a) formed by the second adhesive 72 serves as a guide when the recording medium 200 is conveyed. As a result, it becomes more difficult for the recording medium 200 to enter the path between the support member 30 and the face cover 20. It is preferrable that the second adhesive 72 be a hard material that is not easily scraped when the recording medium 200 comes into contact with the second adhesive 72. It is preferrable that the Young modulus be approximately 7 GPa. It is preferable that the cured second adhesive 72 not protrude from the face cover 20 toward the recording medium 200 in the height direction. It is preferable that the cured second adhesive 72 not adhere to the orifice face 12. It is preferrable that the slope of the second adhesive 72 be gentle, for example, the inclination angle with respect to the surface 32a be 7° or more and 50° or less. In the present exemplary embodiment, as an example, a thermosetting epoxy resin having a pre-cure viscosity of 4.0 Pa·s is used as the first adhesive 71 and the second adhesive 72. The thermosetting epoxy resin is cured by heat at 100° C.

When a large amount of first adhesive 71 is applied such that both the first gap 90 and the second gap 91 are filled with only the first adhesive 71, the first adhesive 71 that cannot be held by the capillary force of the first gap 90 may flow out toward the liquid ejection substrate 13. To avoid this outflow, it is preferable that the resin member 70 be applied in two separate steps as described in the present exemplary embodiment. First, the first adhesive 71 is applied by an amount that can be held by the capillary force of the first gap 90 and is cured. In this way, the second adhesive 72, which is applied next, does not flow out toward the liquid ejection substrate 13. In the present exemplary embodiment, the first gap 90 is filled with the first adhesive 71 by using the capillary force. Accordingly, as illustrated in FIGS. 5B and 7B, the cured first adhesive 71 (first resin) surrounded by a surface 20b of the face cover 20, the surface 20b being bonded to the support member 32, and an inner surface 32b of the support member 32 has a concave shape and does not protrude toward the liquid ejection substrate 13.

It is desirable that the amount of the first adhesive 71 to be applied be accurately controlled. For example, the heights of the face cover 20 and the second support member 32 are measured by a laser displacement gauge or the like, and the amount of the first adhesive 71 to be applied is adjusted based on the measurement result. In this way, the first adhesive 71 can be optimally applied.

Since the groove 321 is provided in the surface 32a of the second support member 32, the applied second adhesive 72 can easily form a slope by surface tension such that the outer peripheral end of the face cover 20 and the outer peripheral end of the groove 321 are connected to each other. Because the second adhesive 72 applied to the groove 321 in the second support member 32 serves as an anchor, the adhesion between the second adhesive 72 and the second support member 32 is improved, and thus, the contact with the recording medium 200 is less likely to cause damage. Further, the face cover 20 is strengthened against the force applied in the direction from the side surface. To more suitably obtain the anchor effect of the disposed resin member 70, it is desirable that the groove 321 have a depth of 0.2 mm or more. In the present exemplary embodiment, as an example, the depth of the groove 321 is set to 0.4 mm (design tolerance ±0.2 mm).

The width of the groove 321 can be determined based on the size of the needle used for applying the resin member 70 (the first adhesive 71 and the second adhesive 72). To prevent the resin member 70 from overflowing from the groove 321 during the application, it is preferrable that a portion of the groove 321 exposed from the face cover 20 have a width greater than the outer diameter of the needle, and more specifically, a width of 1.0 mm or wider, when seen from a direction perpendicular to the surface 32a in which the second support member 32 has the groove 321, in a state where the face cover 20 is disposed. In the present exemplary embodiment, as an example, the width of the groove 321 is set to approximately 2.15 mm, and the amount of the portion of the groove 321 overlapping the face cover 20 in the width direction of the groove 321 is set to approximately 0.6 mm. Accordingly, the width of the portion of the groove 321 that does not overlap the face cover 20 is approximately 1.55 mm. Assuming that the outer diameter of the needle for applying the resin member 70 is 0.72 mm, the needle can easily be inserted into the groove 321 when the resin member 70 is applied.

In the present exemplary embodiment, as an example, the height of the first gap 90 is set to 0.2 mm, the length of the first gap 90 in the width direction of the groove 321 is set to 1.0 mm, the height (depth) of the groove 321 is set to 0.4 mm, and the height of the second gap 91 is set to 0.635 mm. When the second adhesive 72 is applied to the groove 321 having such a structure, the second adhesive 72 can be applied from 0.3 mm to 0.8 mm above the bottom of the groove 321 provided in the second support member 32, for example. Forming a sufficient clearance in the width of the groove 321 in the second support member 32 for the needle provides advantages. For example, the accuracy requirements for the automatic application device used in the adhesive application step are reduced, and the liquid ejection head 100 can be manufactured using a general-purpose application device.

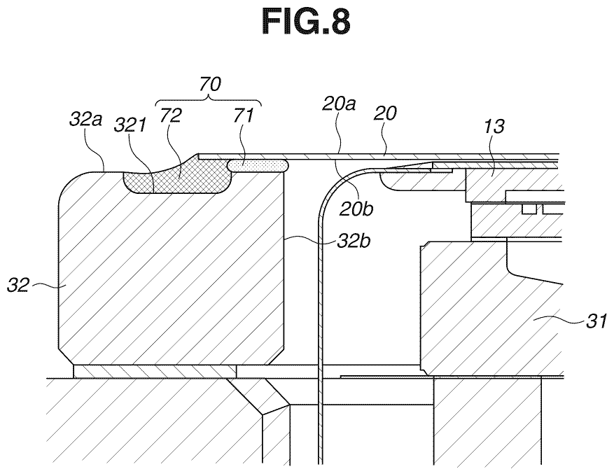

The first adhesive 71 may be applied to the surface 32a of the second support member 32 in advance, and the face cover 20 may be bonded thereto. In this case, the first adhesive 71 is pressed by the face cover 20. Specifically, the first adhesive 71 surrounded by the surface 20b of the face cover 20 and the inner surface 32b of the support member 32 is made convex, as illustrated in FIG. 8.

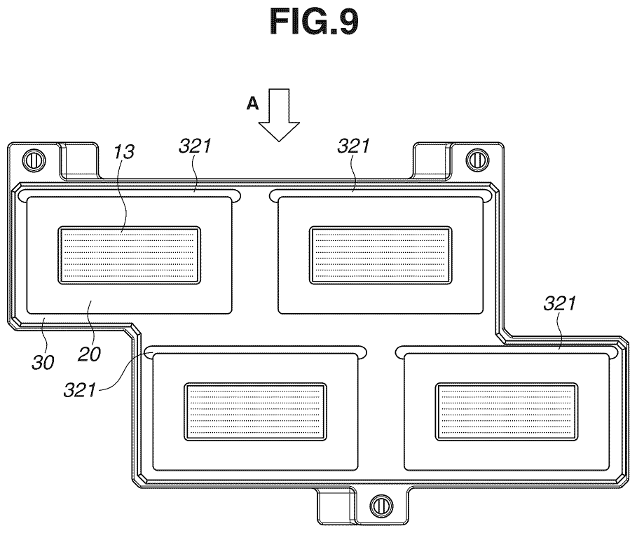

In FIGS. 4A and 6, the individual groove 321 is formed around the entire outer periphery of its corresponding face cover 20. However, the individual groove 321 may be formed differently. For example, as illustrated in FIG. 9, the individual groove 321 is formed around a side located upstream of its corresponding face cover 20 in the conveyance direction A of the recording medium 200. In this way, the individual resin member 70 serves as a guide that prevents entry of the recording medium 200 into the gap between the support member 30 and the corresponding face cover 20, and occurrence of jamming is reduced.

By forming a groove 321 around the outer periphery of each of the face covers 20 as illustrated in FIG. 4A and FIG. 6, the bonding strength between the face covers 20 and the support member 30 can be further strengthened.

A second exemplary embodiment will be described. The following description will focus on the difference between the above-described first exemplary embodiment and the second exemplary embodiment, and description of the same parts as those according to the first exemplary embodiment will be omitted.

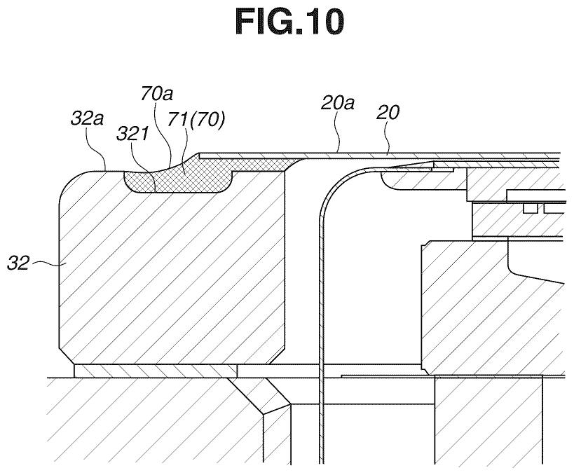

FIG. 10 is a sectional view of a liquid ejection head according to the present exemplary embodiment, and is a view corresponding to FIG. 5B in the first exemplary embodiment. In the present exemplary embodiment, a resin member 70 and an inclined surface 70a are formed only of a first adhesive 71 without using the second adhesive 72 according to the first exemplary embodiment. An all amount of the first adhesive 71 is applied at one time without being thermally cured in the middle of the process. In this case, too, it is preferable that the first adhesive 71 be accurately applied. Accordingly, it is desirable that the distance between a face cover 20 and a support member 32 be measured in advance with a laser displacement gauge or the like. In addition, it is desirable that the optimum amount of the first adhesive 71 be applied by adjusting the amount of the first adhesive 71 to be applied, based on the measurement result.

The first adhesive 71 forms the inclined surface 70a that extends from the surface and the end portion of the face cover 20 to a surface 32a of the second support member 32 over a groove 321. In this formation process, the viscosity of the first adhesive 71 can be suitably selected based on the dimension and the width of the first gap 90 such that the first adhesive 71 will not overflow toward a liquid ejection substrate 13.

The present disclosure can provide a liquid ejection head that reduces occurrence of jamming caused by a recording medium and that has high durability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-077929, filed May 13, 2024, which is hereby incorporated by reference herein in its entirety.

What is claimed is:

1. A liquid ejection head comprising:
a liquid ejection substrate configured to have an orifice face provided with an ejection orifice that ejects liquid;
a face cover configured to be bonded to the liquid ejection substrate and protect the orifice face; and
a support member configured to support the face cover,
wherein the support member is provided with a groove in a surface to which the face cover is bonded, the groove partially overlapping the face cover when seen from a direction perpendicular to the orifice face, and
wherein the liquid ejection head includes resin provided over a space surrounded by the support member and the face cover, and the groove, the resin forming an inclined surface toward the orifice face.

2. The liquid ejection head according to claim 1, wherein a cover surface of the face cover, the cover surface being located on a side opposite to a surface bonded to the support member, the inclined surface, and the surface having the groove form a continuous surface.

3. The liquid ejection head according to claim 1, wherein the groove has a portion that does not overlap the face cover when seen from the direction perpendicular to the orifice face.

4. The liquid ejection head according to claim 1, wherein the face cover has an opening in which the liquid ejection substrate is disposed when seen from the direction perpendicular to the orifice face.

5. The liquid ejection head according to claim 4, wherein the groove is surrounding the opening when seen from the direction perpendicular to the orifice face.

6. The liquid ejection head according to claim 1, wherein the space surrounded by the support member and the face cover and the groove are filled with the resin.

7. The liquid ejection head according to claim 1, wherein the resin surrounded by a surface of the face cover, the surface being bonded to the support member, and a side surface of the support member has a concave shape.

8. The liquid ejection head according to claim 1, wherein the resin includes a first resin disposed in the space surrounded by the support member and the face cover and a second resin disposed in the groove.

9. The liquid ejection head according to claim 1, wherein the support member and the face cover are bonded to each other via the resin.

10. A liquid ejection apparatus comprising:
a liquid ejection substrate configured to have an orifice face provided with an ejection orifice that ejects liquid;
a face cover configured to be bonded to the liquid ejection substrate and protect the orifice face;
a support member configured to support the face cover and be provided with a groove in a surface to which the face cover is bonded, the groove partially overlapping the face cover when seen from a direction perpendicular to the orifice face;
a liquid ejection head configured to include resin provided over a space surrounded by the support member and the face cover, and the groove, the resin forming an inclined surface toward the orifice face; and
a conveyance unit configured to convey a medium to which the liquid ejection head ejects liquid.

11. The liquid ejection apparatus according to claim 10, wherein the groove has a portion located upstream of the liquid ejection substrate in a conveyance direction of the medium when seen from the direction perpendicular to the orifice face.

12. A method for manufacturing a liquid ejection head that includes:
a liquid ejection substrate configured to have an orifice face provided with an ejection orifice that ejects liquid;
a face cover configured to be bonded to the liquid ejection substrate and protect the orifice face; and
a support member configured to support the face cover,
wherein the support member is provided with a groove in a surface to which the face cover is bonded, the groove partially overlapping the face cover when seen from a direction perpendicular to the orifice face, the method comprising disposing resin over a space surrounded by the support member and the face cover, and the groove such that the resin forms an inclined surface toward the orifice face.

13. The method for manufacturing the liquid ejection head according to claim 12,
wherein the resin includes a first resin and a second resin,
wherein the disposing of the resin includes:
disposing the first resin in the space surrounded by the support member and the face cover and curing the first resin; and
disposing the second resin in the groove and curing the second resin, and
wherein the disposing of the first resin and the disposing of the second resin are performed in this order.

14. The method for manufacturing the liquid ejection head according to claim 13, further comprising disposing the face cover on the support member such that the space is formed, prior to the disposing of the resin.

15. The method for manufacturing the liquid ejection head according to claim 14, wherein the first resin is disposed in the space by capillary force.

16. The method for manufacturing the liquid ejection head according to claim 13, wherein disposing the first resin which viscosity is 4.0 Pa·s or more and 132 Pa·s or less.

17. The method for manufacturing the liquid ejection head according to claim 12, wherein the resin is disposed such that a cover surface of the face cover, the cover surface being located on a side opposite to a surface bonded to the support member, a surface of the resin, and the surface in which the support member has the groove form a continuous surface.
